(19) United States
(12) Patent Application Publication
(10) Pub. No.: US 2004/0130988 A1
(43) Pub. Date: Jul. 8, 2004

(54) Method for detecting upside down disk placement in an optical disk reading device

(76) Inventors: Kuo-Pei Weng, Kaohsiung City (TW); Chien-Li Hung, Hsinchu City (TW)

Correspondence Address: Raymond Sun, 12420 Woodhall Way, Tustin, CA, 92782, US

(21) Appl. No.: 10/626,177

(22) Filed: Jul. 24, 2003

(30) Foreign Application Priority Data
Oct. 15, 2002 (TW) 91123755

(51) Int. Cl. G11B 7/00

(52) U.S. Cl. 369/53.2; 369/53.37; 369/53.3

(57) ABSTRACT

A method is provided for determining whether a disk is positioned upside down inside an optical disk player. According to this method, a disk is loaded into an optical disk player, and then a laser beam is emitted that travels via a focusing device in the optical disk player to the loaded disk. Then, the focusing device is moved from a first position to a second position. While the focusing device is being moved from the first position to the second position, the variation in the intensity of the laser beam that is reflected by the disk is continuously recorded to produce a distribution curve of the intensity of the reflected laser beam. Thereafter, the method determines whether the disk is upside down based on the obtained distribution curve.

### BACKGROUND OF THE INVENTION

1. Field of the Invention

The present invention relates to an optical disk reading device, and in particular, to a method for detecting whether a disk has been placed upside down in an optical disk reading device.

2. Description of the Prior Art

Along with the development of computer hardware and internet technology, currently there is great demand for data storage media. In particular, multimedia data, such as video or audio data, still occupy fairly large amounts of memory space even after they have been compressed. Consequently, the development of data storage media, such as MOs (magneto-optical disc), recordable optical disks (CD-R, CD-RW), or high-capacity soft disks (JAZZ), has been pursued without sparing any effort. This pursuit has been especially intensive for the optical disk family, because the popularity of audio compact disks (Audio CD) and read-only memory optical disks (CD-ROM) have meant that recordable optical disks (CD-R, CD-RW) have found a ready market. In particular, since the prices of CD-recorders and recordable disks have dropped sharply, and optical disks have become popular as bonus materials attached to books and magazines, optical disks have become an indispensable part of daily life.

General users often use disk collection boxes or collection folders to store large quantities of CD-ROMS or video/audio disks. In many cases, a user will not clearly state the file contents on the printed surface of the user's many optical disks. Therefore, the user often uses the trial-and-error method to check the contents of the optical disks one at a time in order to find the required data. However, if the optical disk is scratched or is placed upside-down, the optical disk reading device (also referred to hereinafter as an “optical disk player”, “disk player” or “disk drive”) will usually need a complicated detection procedure to check the contents of the disk. If it is necessary to read a large number of disks, a lot of time can be wasted by the user.

FIG. 1 shows an optical head reading a disk 20, and also shows the related elements of a conventional optical disk player. The optical head includes a laser diode 10, which emits a laser beam at a prescribed wavelength. After the beam passes through a polarizing beam splitter 11, it is collimated into a parallel light beam by a collimator 12 so that the signal will not be misinterpreted when a downstage lens is moved along the optical axis. The parallel light passes through a pi/4 plate 13, which converts the original linearly polarized light into circularly polarized light. After the circularly polarized light is focused by an objective lens 14, it forms a light spot SP on the disk 20. An objective lens actuator 32 is driven by a drive circuit 30 to control the movement of the objective lens 14 along the optical axis (i.e., moves the objective lens 14 up and down) to change the position of light spot SP so that the light spot SP can be focused on the information layer of the disk 20. The light spot SP is reflected by the information layer of the disk 20. After the reflected light again passes through objective lens 14 and pi/4 plate 13, the circularly polarized light is converted into linearly polarized light, which ultimately reaches the polarizing beam splitter 11 via the collimator 12. At this time, since the linear polarization direction of the reflected light beam is perpendicular to the polarization direction of the original light beam, it will be reflected onto a focusing lens 15 and then received by an optical sensor 16. The electronic signal detected by optical sensor 16 is sent to an error detector 31, where the electronic signal is interpreted in order to obtain the information signal and various types of servo signals (such as focus error (FE) signal, tracking error (TE) signal, sub-beam added (SBAD) signal, RF signal, and motor control signal) from the light beam.

The conventional disk interpretation mechanism takes advantage of the variations in the aforementioned servo signals to obtain the focusing situation. However, a typical optical disk player can only identify two conditions: (i) that there is no disk, or (ii) the existence of several types of known disks, such as CD-ROM, CD-R, and CD-RW. Therefore, if the user inserts a disk upside down, the disk player will not be able to focus correctly, so the disk player will send a failure message to the microprocessor after a series of retries. This is time-consuming and unproductive.

### SUMMARY OF THE DISCLOSURE

It is an objective of the present invention to provide a method that can quickly detect whether a disk is placed upside-down inside an optical disk player.

In order to accomplish the objects of the present invention, the present invention provides a method for determining whether a disk is positioned upside down inside an optical disk player. According to this method, a disk is loaded into an optical disk player, and then a laser beam is emitted that travels via a focusing device in the optical disk player to the loaded disk. Then, the focusing device is moved from a first position to a second position. While the focusing device is being moved from the first position to the second position, the variation in the intensity of the laser beam that is reflected by the disk is continuously recorded to produce a distribution curve of the intensity of the reflected laser beam. Thereafter, the method determines whether the disk is upside down based on the obtained distribution curve.

### BRIEF DESCRIPTION OF THE DRAWINGS

FIG. 1 is a simple illustration of a signal reading system of an optical disk player that can be used to implement the method of the present invention.

FIG. 2 is a graph that illustrates the relationship between the rotation speed and the loaded disk after driving a period of time.

FIG. 3 is a graph that illustrates the banded distribution of the data in FIG. 2.

FIG. 4 illustrates how focusing is performed in the various cases of a disk being inserted correctly, and inserted upside-down.

FIG. 5 illustrates the reflection when a disk has been inserted correctly, and inserted upside-down.

FIG. 6 is a flowchart illustrating how an optical disk player can detect an upside-down disk in a method according to the present invention.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

The present invention provides a method used for determining whether a disk has been inserted upside down. This method includes a procedure used for determining the presence of the disk and a procedure used for checking the light reflection curve.

To determine whether a disk is positioned upside-down inside an optical disk player, it is necessary to first determine whether there is a disk in the optical disk player. The present invention uses a voltage with special waveform to drive the spindle motor. As shown in FIG. 2, the voltage with a special waveform includes a relatively high voltage Vt1 during a first time interval T1 and a relatively low voltage Vt2 during a second time interval T2. The relatively high voltage Vt1 is used to overcome static friction, while the relatively low voltage Vt2 is used to drive the spindle motor that has started to rotate. As shown in FIG. 2, if a 12 cm disk is loaded in the disk drive, since the moment of inertia of the spindle motor is relatively high, the acceleration is relatively low. After the spindle motor is accelerated for a period of time, the measured speed of the spindle motor will be relatively low (curve C1). If there is no disk in the disk drive, since the moment of inertia of the spindle motor is relatively low, the acceleration will be relatively high. After the spindle motor is accelerated for a period of time, the measured speed of the spindle motor will be relatively high (curve C3). If the loaded disk is a minidisk (e.g., 8 cm disk) or a card-shaped disk which is lighter than the generic 12 cm disk, the moment of inertia of the spindle motor is between the abovementioned two cases. Consequently, a threshold can be set for the speed. If the speed V is below a first threshold speed V1 after a prescribed period of time, it means that the disk is generic. If the speed V is above a second threshold speed V2 after a prescribed period of time, it means that there is no disk in the disk drive. If the speed V is between the first threshold speed V1 and the second threshold speed V2 after a prescribed period of time, it means that the disk is a minidisk.

After the procedure for determining the existence of the disk is carried out, if it is found that there is a disk in the disk drive, the light beam reflection curve checking procedure (described below) can be carried out to determine if the disk is upside-down. In this procedure, the rotation speed of the spindle motor can be measured by a sensor incorporated in the disk player, such as a Hall sensor. Then, the measured speed is fed back to the processor of the disk player and compared with the first threshold speed V1 and the second threshold speed V2 stored in the memory unit (such as a ROM) to detect the state of the disk.

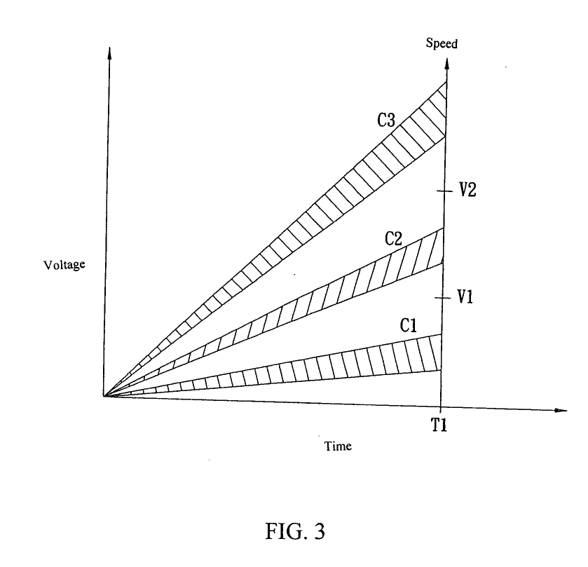

In the above-described procedure for determining the existence of the disk, it should be noted that the applied spindle motor drive voltage must be able to distinguish between each of the three abovementioned situations. Since the weight of each disk can be slightly off, after a prescribed period of time, the speed will become different and exhibit the banded distribution shown in FIG. 3. Consequently, the level of the applied voltage and the prescribed period of time should be set appropriately in order to detect the corresponding state of the disk using the given first threshold speed V1 and second threshold speed V2.

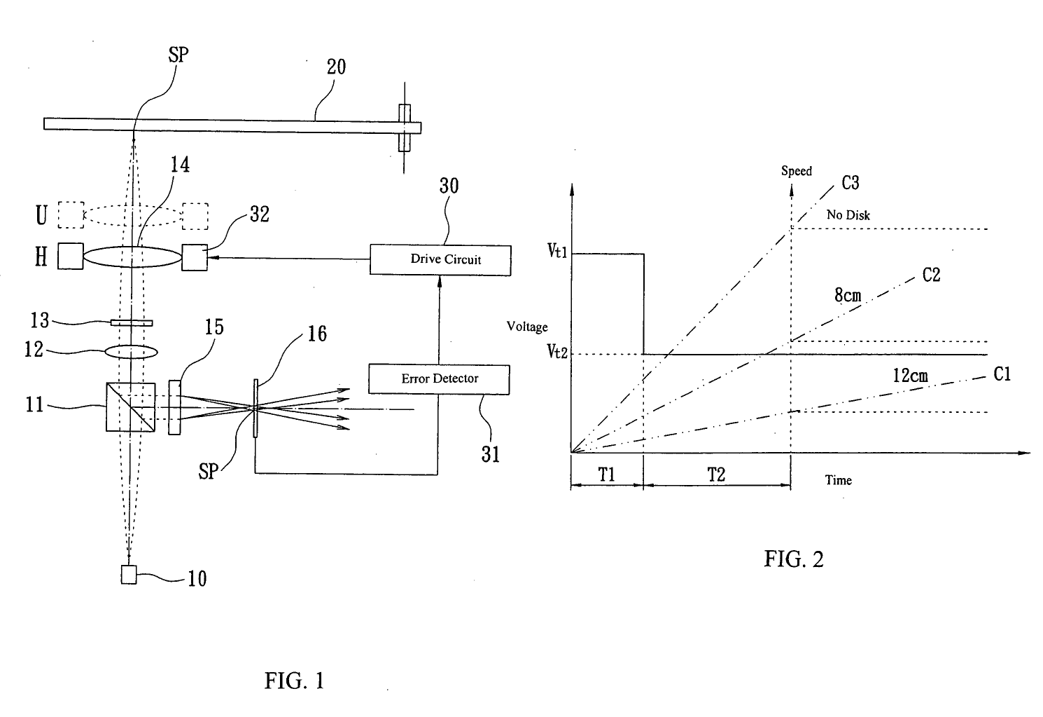

Referring to FIG. 1, in the method for determining whether a disk is upside-down, after it is confirmed that there is a disk 20 in the disk player, the objective lens 14 is first moved to a first position H. In other words, the distance between the disk 20 and the objective lens 14 is maximized. Then, after a laser beam is output, the objective lens 14 is moved at a prescribed speed along the optical axis to a second position U. In other words, the distance between the disk 20 and the objective lens 14 is minimized. The optical sensor 16 is used to measure the intensity of the laser beam reflected by the disk 20 when objective lens 14 is being moved and to record the relationship between the position of the objective lens 14 and the reflection intensity.

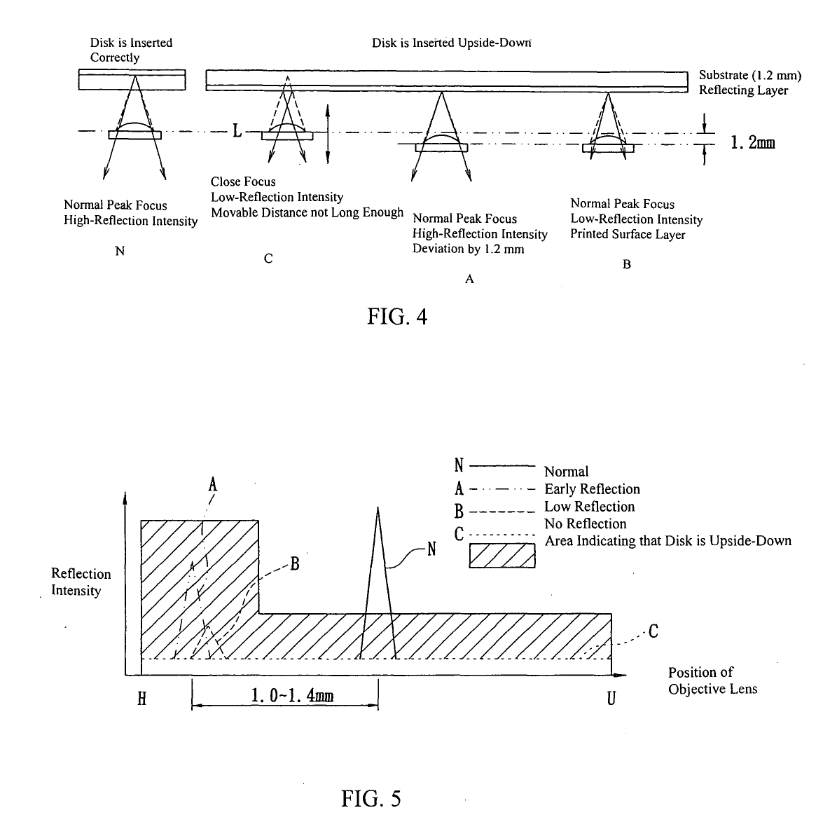

As shown in FIGS. 4 and 5, if the disk 20 has been loaded correctly (i.e., if the transparent base material is at the bottom while the information layer with relatively high reflectivity is at the top), the focused light spot of the light beam will be reflected by the information layer after passing through the transparent base material. See case N in FIG. 4. As a result, the reflection intensity distribution curve will look like curve N shown in FIG. 5. Based on the design of the disk player, the highest reflection intensity will occur at the mid-point between the first position H and the second position U.

If the disk 20 is positioned upside-down in the disk player, one of the three following situations will occur.

(A) Since the disk 20 is in upside down, the focused light spot of the light beam will first reach the information layer with relatively high reflectivity. As a result, the reflection intensity distribution curve of the early reflection will resemble curve A in FIG. 5, and is illustrated by case A in FIG. 4. The thickness of the transparent base material of a generic disk is about 1.2 mm. Therefore, the peak of the reflection intensity distribution curve A will occur about 1.0-1.4 mm earlier than the peak of the normal reflection intensity distribution curve N.

(B) Under some circumstances, the laser beam will be absorbed by the label surface of the disk, and thus there is only a very low level of reflected light. As a result, early reflection will occur as shown by curve B in FIG. 5, and is illustrated by case B in FIG. 4. However, the peak is relatively low.

(C) For some optical disk players (in particular, thin disk players), since the movable distance of the objective lens 14 is not long enough (i.e., very short), there is the possibility that the focused light spot is unable to reach the information layer with relatively high reflectivity. In other words, the focused light spot of the laser beam is always in the transparent base material during movement of the objective lens 14, or there is only very low reflection due to the difference in the index of refraction at the base-material-to-air-interface, as shown by curve C in FIG. 5, and which is illustrated by case C in FIG. 4.

Consequently, it is possible to pre-store in a memory (e.g., ROM or RAM) the parameters of the reflection intensity distributions for a disk 20 that has been inserted correctly or upside-down. For example, the normal peak position and the threshold of the peak magnitude can be set. In a first situation, if (i) a peak exceeds the threshold value, and (ii) its position is earlier than the normal peak position N, and (iii) the distance to the normal peak position is in the range of 1.0-1.4 mm, then it means that the disk 20 is upside down as in case A. In a second situation, if the reflection intensity distribution is below the threshold, then case B or case C applies, which also indicates that the disk 20 is upside down. The hatched part shown in FIG. 5 is almost shaped like an L and includes a reflection peak deviated area on the left side and a low reflection area at the bottom. If the reflection intensity distribution curve falls into this hatched part, it means that the disk is upside-down.

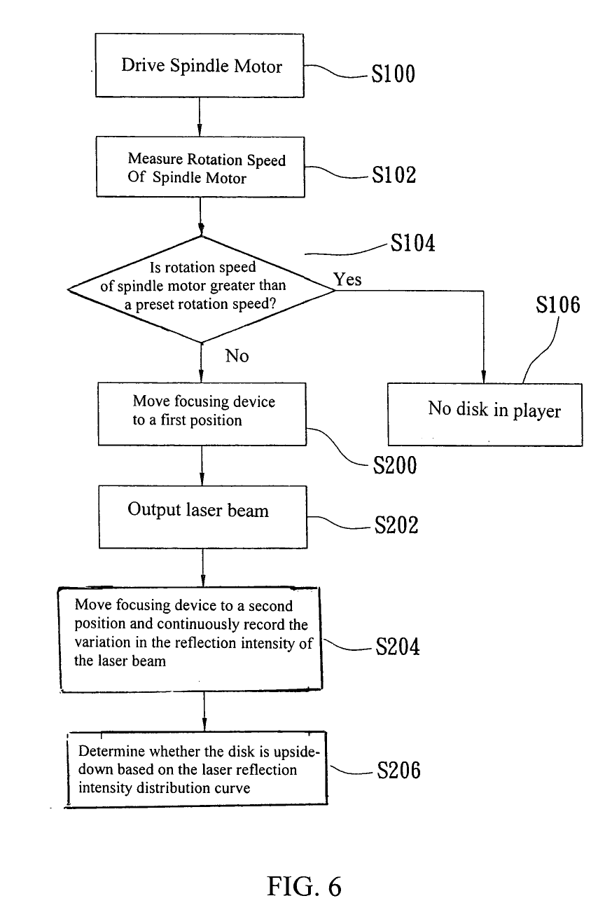

As shown in FIGS. 1 and 6, the method provided by the present invention for determining whether a disk 20 is upside-down includes the following steps.

Step S100: Apply a drive voltage to rotate the spindle motor with a prescribed waveform.

Step S102: Measure the rotation speed of the spindle motor.

Step S104: Is the speed of rotation of the spindle motor greater than a preset speed of rotation within a prescribed period of time? If yes, the process goes to step S106 (i.e., there is no disk in the disk player). If no, then the process continues to step S200.

Step 106: There is no disk 20 in the disk player and a system error message is returned.

Step S200: Move the objective lens (i.e., the focusing device) 14 of the optical head to the first position H.

Step S202: Output a laser beam.

Step S204: Move the objective lens 14 of the optical head to the second position U and continuously record the variation in the reflection intensity of the laser beam when the objective lens 14 is being moved from the first position to the second position.

Step S206: Determine whether the disk 20 is upside-down based on the laser reflection intensity distribution curve.

In step S100, a drive voltage with a prescribed waveform is applied to turn the spindle motor. As shown in FIG. 2, the voltage with the prescribed waveform includes a relatively high voltage Vt1 in the first time interval T1and a relatively low voltage Vt2 in the second time interval T2. The relatively high voltage Vt1 is used to overcome static friction, while the relatively low voltage Vt2 is used to drive the spindle motor that has started to rotate.

In step S102, the rotation speed of the spindle motor is measured. Generic optical disk players all have a sensor that can measure the rotation speed of the spindle motor and output the rotation speed of the spindle motor in the form of an FG signal.

In step S104, it is determined whether the rotation speed of the spindle motor is higher than a preset rotation speed within a prescribed period of time. In order to distinguish between different disks, such as a generic 12 cm disk, a minidisk (8 cm), or a card-shaped disk, it is desirable to use two different threshold speeds. If the rotation speed V of the spindle motor is below the first threshold speed V1 after a prescribed period of time, it means that the disk 20 is a generic disk. If the speed V is above the second threshold speed V2 after a prescribed period of time, it means that is no disk 20. If the speed is between the first threshold speed V1 and the second threshold speed V2 after a prescribed period of time, it means that the disk 20 is a minidisc, as shown in FIG. 2. If the rotation speed is higher than the second threshold speed V2, it means there is no disk 20 in the disk player, and the process will proceed to step S106 to confirm that there is no disk 20 and return a system error message. Otherwise, the process proceeds to step S200.

In step S200, the focusing device of the optical head is moved to the first position H. Then, after a laser beam is output in step S202, in step S204, the focusing device (i.e., objective lens 14) of the optical head is moved from the first position to the second position U, and the variation in the reflection intensity of the laser beam during movement of the focusing device is continuously recorded. However, as an alternative, it is also possible to first move the focusing device of the optical head to the second position U in step S200, and then after the laser beam has been output, the focusing device of the optical head can then be moved to the first position H. In other words, the movements of the focusing device can be operated in either direction (from H to U, or from U to H).

In step S206, it is determined whether the disk 20 is upside-down based on the laser reflection curve. The parameters of the peak position and peak magnitude can be derived from the laser reflection intensity distribution curve, and compared with the parameters of the reflection intensity distribution curves stored in memory for a disk 20 that has been inserted correctly and for a disk 20 that has been inserted upside down. For example, the normal peak position and the threshold of the peak magnitude can be set. If (i) the peak position is earlier than the normal peak position, and (ii) the distance to the normal peak position is in the range of 1.0-1.4 mm, it means that the disk 20 is upside-down. In addition, if the distribution of the reflection intensity is lower than a threshold value, it means that (i) the light beam might have been absorbed by the printed layer of the disk 20, or (ii) the movable distance of the objective lens 14 is not long enough, which also indicate that the disk 20 is upside-down. If the reflection intensity distribution graph falls into the hatched part shown in FIG. 5, it means that the disk is placed upside down.

Thus, the method provided by the present invention can quickly determine whether a disk 20 is upside-down. Consequently, the present invention can save a great amount of operating time and improve the overall efficiency of an optical disk player.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A method for determining whether a disk is positioned upside down inside an optical disk player, comprising:
a. loading a disk into an optical disk player which has a focusing device;
b. emitting a laser beam that travels via the focusing device to the loaded disk;
c. moving the focusing device from a first position to a second position;
d. while the focusing device is being moved from the first position to the second position, continuously recording the variation in the intensity of the laser beam that is reflected by the disk to produce a distribution curve of the intensity of the reflected laser beam; and
e. determining whether the disk is upside down based on the obtained distribution curve.

2. The method of claim 1, wherein step (e) further includes:
comparing the obtained distribution curve with a prescribed reference reflection intensity distribution curve to determine whether the disk is upside down.

3. The method of claim 1, further including:
prior to step (b):
(i) rotating a spindle motor of the optical disk player based on a prescribed waveform;
(ii) measuring the rotation speed of the spindle motor;
(iii) determining that there is no disk in the optical disk player if the rotation speed of the spindle motor is greater than a preset speed of rotation within a prescribed period of time, otherwise erforming step (c).
